(19) United States
(12) Patent Application Publication
(10) Pub. No.: US 2024/0112628 A1
(43) Pub. Date: Apr. 4, 2024

(54) Displays with Selective Pixel Brightness Tuning

(71) Applicant: Apple Inc., Cupertino, CA (US)

(72) Inventors: Yunhui Hou, San Jose, CA (US); Yi-Pai Huang, Zhubei (TW); Fu-Chung Huang, Cupertino, CA (US); Sheng Zhang, San Jose, CA (US); Chaohao Wang, Shanghai (CN); Ping-Yen Chou, Santa Clara, CA (US); Yi Huang, San Jose, CA (US); Juan He, San Jose, CA (US); Alfred B. Huergo Wagner, Redwood City, CA (US); Seung Wook Kim, San Jose, CA (US)

(21) Appl. No.: 18/540,602

(22) Filed: Dec. 14, 2023

Related U.S. Application Data
(63) Continuation of application No. 18/259,619, filed on Jun. 28, 2023, now abandoned.
(60) Provisional application No. 63/136,005, filed on Jan. 11, 2021.

(51) Int. Cl. G09G 3/3208

(52) U.S. Cl. CPC G09G 3/3208; G09G 2320/0209; G09G 2320/0626

(57) ABSTRACT

An electronic device may include a lenticular display. The lenticular display may have a lenticular lens film formed over an array of pixels. A plurality of lenticular lenses may extend across the length of the display. The lenticular lenses may be configured to enable stereoscopic viewing of the display such that a viewer perceives three-dimensional images. The display may have a number of independently controllable viewing zones. The viewer may be particularly susceptible to artifacts caused by crosstalk at the edge viewing zones within the primary field of view of the display. Certain types of content may also be more vulnerable to crosstalk than other types of content. Therefore, to mitigate crosstalk artifacts, the pixel value for each pixel may be adjusted based on the viewing zone of the respective pixel and content information (such as texture information or brightness information) associated with the respective pixel.

This application is a continuation of U.S. patent application Ser. No. 18/259,619, filed Jun. 28, 2023, which is a national stage application filed under 35 U.S.C. § 371 of international patent application No. PCT/US22/11219, filed Jan. 5, 2022, which claims priority to U.S. provisional patent application No. 63/136,005, filed Jan. 11, 2021, which are hereby incorporated by reference herein in their entireties.

### FIELD

This relates generally to electronic devices, and, more particularly, to electronic devices with displays.

### BACKGROUND

Electronic devices often include displays. In some cases, displays may include lenticular lenses that enable the display to provide three-dimensional content to the viewer. The lenticular lenses may be formed over an array of pixels such as organic light-emitting diode pixels or liquid crystal display pixels.

### SUMMARY

An electronic device may include a lenticular display. The lenticular display may have a lenticular lens film formed over an array of pixels. A plurality of lenticular lenses may extend across the length of the display. The lenticular lenses may be configured to enable stereoscopic viewing of the display such that a viewer perceives three-dimensional images.

The display may have a number of independently controllable viewing zones. Each viewing zone displays a respective two-dimensional image. Each eye of the viewer may receive a different one of the two-dimensional images, resulting in a perceived three-dimensional image.

The electronic device may include display pipeline circuitry that generates and processes content to be displayed on the lenticular display. Content generating circuitry may initially generate content that includes a plurality of two-dimensional images, each two-dimensional image corresponding to a respective viewing zone.

Pixel mapping circuitry may be used to map the two-dimensional images to the array of pixels in the lenticular display. Each two-dimensional image may have a respective subset of pixels on the display, such that the two-dimensional images are blended together and displayed simultaneously.

The pixel values for the array of pixels may be selectively dimmed to mitigate artifacts caused by crosstalk between viewing zones. The viewer may be particularly susceptible to artifacts caused by crosstalk at the edge viewing zones within the primary field of view of the display. Certain types of content may also be more vulnerable to crosstalk than other types of content. Therefore, the pixel value for each pixel may be dimmed based on the viewing zone of the respective pixel and content information (such as texture information or brightness information) associated with the respective pixel.

In some cases, brightness values for the array of pixels may be selectively increased to increase contrast. The brightness values may be increased in portions of the display that are susceptible to reflections from ambient light such as the edges of the display.

### BRIEF DESCRIPTION OF THE DRAWINGS

FIG. 1 is a schematic diagram of an illustrative electronic device having a display in accordance with an embodiment.

FIG. 2 is a top view of an illustrative display in an electronic device in accordance with an embodiment.

FIG. 3 is a cross-sectional side view of an illustrative lenticular display that provides images to a viewer in accordance with an embodiment.

FIG. 4 is a cross-sectional side view of an illustrative lenticular display that provides images to two or more viewers in accordance with an embodiment.

FIG. 5 is a top view of an illustrative lenticular lens film showing the elongated shape of the lenticular lenses in accordance with an embodiment.

FIG. 6 is a diagram of an illustrative lenticular display with a plurality of discrete viewing zones in accordance with an embodiment.

FIGS. 7A-7C are perspective views of illustrative three-dimensional content that may be displayed on different zones of the display of FIG. 6 in accordance with an embodiment.

FIG. 8 is a diagram showing how crosstalk may be present in a given viewing zone of a lenticular display in accordance with an embodiment.

FIG. 9 is a top view of an illustrative display showing a ghosting effect caused by crosstalk in accordance with an embodiment.

FIG. 10 is a diagram of an illustrative display with display pipeline circuitry that generates images for a lenticular display in accordance with an embodiment.

FIG. 11 is a diagram of an illustrative display showing how display pipeline circuitry may include content rendering circuitry and pixel mapping circuitry in accordance with an embodiment.

FIG. 12 is a diagram of illustrative view-dependent luminance adjustment circuitry in accordance with an embodiment.

### DETAILED DESCRIPTION

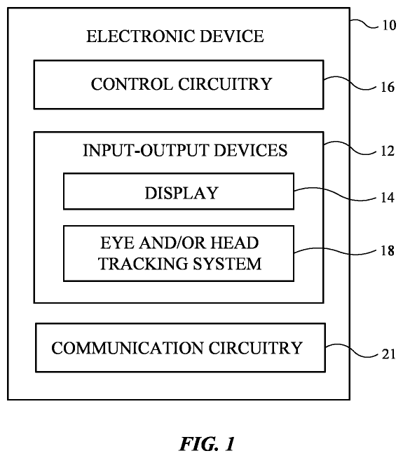

An illustrative electronic device of the type that may be provided with a display is shown in FIG. 1. Electronic device 10 may be a computing device such as a laptop computer, a computer monitor containing an embedded computer, a tablet computer, a cellular telephone, a media player, or other handheld or portable electronic device, a smaller device such as a wrist-watch device, a pendant device, a headphone or earpiece device, an augmented reality (AR) headset and/or virtual reality (VR) headset, a device embedded in eyeglasses or other equipment worn on a user's head, or other wearable or miniature device, a display, a computer display that contains an embedded computer, a computer display that does not contain an embedded computer, a gaming device, a navigation device, an embedded system such as a system in which electronic equipment with a display is mounted in a kiosk or automobile, or other electronic equipment. As shown in FIG. 1, electronic device 10 may have control circuitry 16. Control circuitry 16 may include storage and processing circuitry for supporting the operation of device 10. The storage and processing circuitry may include storage such as hard disk drive storage, nonvolatile memory (e.g., flash memory or other electrically-programmable-read-only memory configured to form a solid-state drive), volatile memory (e.g., static or dynamic random-access-memory), etc. Processing circuitry in control circuitry 16 may be used to control the operation of device 10. The processing circuitry may be based on one or more microprocessors, microcontrollers, digital signal processors, baseband processors, power management units, audio chips, application specific integrated circuits, etc.

To support communications between device 10 and external equipment, control circuitry 16 may communicate using communications circuitry 21. Circuitry 21 may include antennas, radio-frequency transceiver circuitry, and other wireless communications circuitry and/or wired communications circuitry. Circuitry 21, which may sometimes be referred to as control circuitry and/or control and communications circuitry, may support bidirectional wireless communications between device 10 and external equipment over a wireless link (e.g., circuitry 21 may include radio-frequency transceiver circuitry such as wireless local area network transceiver circuitry configured to support communications over a wireless local area network link, near-field communications transceiver circuitry configured to support communications over a near-field communications link, cellular telephone transceiver circuitry configured to support communications over a cellular telephone link, or transceiver circuitry configured to support communications over any other suitable wired or wireless communications link) Wireless communications may, for example, be supported over a Bluetooth® link, a WiFi® link, a 60 GHz link or other millimeter wave link, a cellular telephone link, or other wireless communications link Device 10 may, if desired, include power circuits for transmitting and/or receiving wired and/or wireless power and may include batteries or other energy storage devices. For example, device 10 may include a coil and rectifier to receive wireless power that is provided to circuitry in device 10.

Input-output circuitry in device 10 such as input-output devices 12 may be used to allow data to be supplied to device 10 and to allow data to be provided from device 10 to external devices. Input-output devices 12 may include buttons, joysticks, scrolling wheels, touch pads, keypads, keyboards, microphones, speakers, tone generators, vibrators, cameras, sensors, light-emitting diodes and other status indicators, data ports, and other electrical components. A user can control the operation of device 10 by supplying commands through input-output devices 12 and may receive status information and other output from device 10 using the output resources of input-output devices 12.

Input-output devices 12 may include one or more displays such as display 14. Display 14 may be a touch screen display that includes a touch sensor for gathering touch input from a user or display 14 may be insensitive to touch. A touch sensor for display 14 may be based on an array of capacitive touch sensor electrodes, acoustic touch sensor structures, resistive touch components, force-based touch sensor structures, a light-based touch sensor, or other suitable touch sensor arrangements.

Some electronic devices may include two displays. In one possible arrangement, a first display may be positioned on one side of the device and a second display may be positioned on a second, opposing side of the device. The first and second displays therefore may have a back-to-back arrangement. One or both of the displays may be curved.

Sensors in input-output devices 12 may include force sensors (e.g., strain gauges, capacitive force sensors, resistive force sensors, etc.), audio sensors such as microphones, touch and/or proximity sensors such as capacitive sensors (e.g., a two-dimensional capacitive touch sensor integrated into display 14, a two-dimensional capacitive touch sensor overlapping display 14, and/or a touch sensor that forms a button, trackpad, or other input device not associated with a display), and other sensors. If desired, sensors in input-output devices 12 may include optical sensors such as optical sensors that emit and detect light, ultrasonic sensors, optical touch sensors, optical proximity sensors, and/or other touch sensors and/or proximity sensors, monochromatic and color ambient light sensors, three-dimensional sensors (e.g., three-dimensional image sensors such as structured light sensors that emit beams of light and that use two-dimensional digital image sensors to gather image data for three-dimensional images from light spots that are produced when a target is illuminated by the beams of light, binocular three-dimensional image sensors that gather three-dimensional images using two or more cameras in a binocular imaging arrangement, three-dimensional lidar (light detection and ranging) sensors, three-dimensional radio-frequency sensors, or other sensors that gather three-dimensional image data), cameras (e.g., infrared and/or visible digital image sensors), fingerprint sensors, temperature sensors, sensors for measuring three-dimensional non-contact gestures (“air gestures”), pressure sensors, sensors for detecting position, orientation, and/or motion (e.g., accelerometers, magnetic sensors such as compass sensors, gyroscopes, and/or inertial measurement units that contain some or all of these sensors), health sensors, radio-frequency sensors, depth sensors (e.g., structured light sensors and/or depth sensors based on stereo imaging devices), humidity sensors, moisture sensors, gaze tracking sensors, and/or other sensors.

Control circuitry 16 may be used to run software on device 10 such as operating system code and applications. During operation of device 10, the software running on control circuitry 16 may display images on display 14 using an array of pixels in display 14.

Display 14 may be an organic light-emitting diode display, a liquid crystal display, an electrophoretic display, an electrowetting display, a plasma display, a microelectromechanical systems display, a display having a pixel array formed from crystalline semiconductor light-emitting diode dies (sometimes referred to as microLEDs), and/or other display. Configurations in which display 14 is an organic light-emitting diode display are sometimes described herein as an example.

Display 14 may have a rectangular shape (i.e., display 14 may have a rectangular footprint and a rectangular peripheral edge that runs around the rectangular footprint) or may have other suitable shapes. Display 14 may have one or more rounded corners. Display 14 may be planar or may have a curved profile.

Device 10 may include cameras and other components that form part of gaze and/or head tracking system 18. The camera(s) or other components of system 18 may face an expected location for a viewer and may track the viewer's eyes and/or head (e.g., images and other information captured by system 18 may be analyzed by control circuitry 16 to determine the location of the viewer's eyes and/or head). This head-location information obtained by system 18 may be used to determine the appropriate direction with which display content from display 14 should be directed. Eye and/or head tracking system 18 may include any desired number/combination of infrared and/or visible light detectors. Eye and/or head tracking system 18 may optionally include light emitters to illuminate the scene.

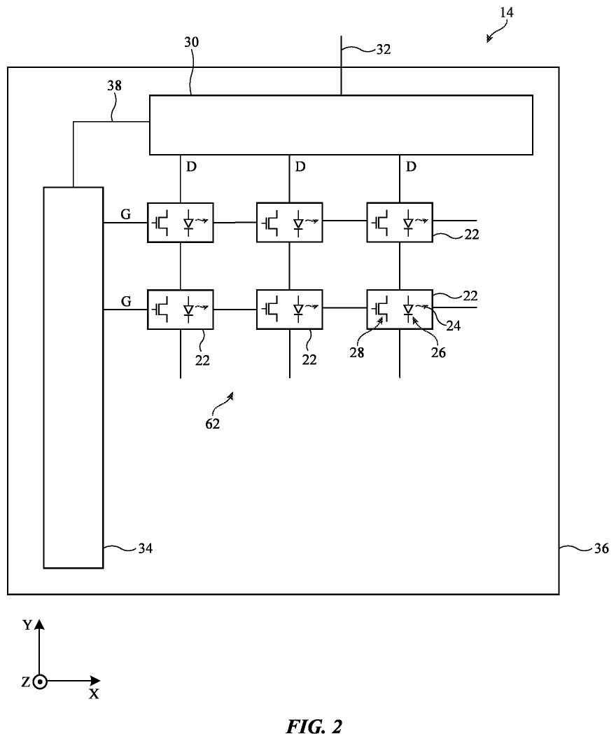

A top view of a portion of display 14 is shown in FIG. 2. As shown in FIG. 2, display 14 may have an array 62 of pixels 22 formed on substrate 36. Substrate 36 may be formed from glass, metal, plastic, ceramic, or other substrate materials. Pixels 22 may receive data signals over signal paths such as data lines D and may receive one or more control signals over control signal paths such as horizontal control lines G (sometimes referred to as gate lines, scan lines, emission control lines, etc.). There may be any suitable number of rows and columns of pixels 22 in display 14 (e.g., tens or more, hundreds or more, or thousands or more). Each pixel 22 may have a light-emitting diode 26 that emits light 24 under the control of a pixel circuit formed from thin-film transistor circuitry (such as thin-film transistors 28 and thin-film capacitors). Thin-film transistors 28 may be polysilicon thin-film transistors, semiconducting-oxide thin-film transistors such as indium gallium zinc oxide transistors, or thin-film transistors formed from other semiconductors. Pixels 22 may contain light-emitting diodes of different colors (e.g., red, green, and blue diodes for red, green, and blue pixels, respectively) to provide display 14 with the ability to display color images.

Display driver circuitry may be used to control the operation of pixels 22. The display driver circuitry may be formed from integrated circuits, thin-film transistor circuits, or other suitable circuitry. Display driver circuitry 30 of FIG. 2 may contain communications circuitry for communicating with system control circuitry such as control circuitry 16 of FIG. 1 over path 32. Path 32 may be formed from traces on a flexible printed circuit or other cable. During operation, the control circuitry (e.g., control circuitry 16 of FIG. 1) may supply circuitry 30 with information on images to be displayed on display 14.

To display the images on display pixels 22, display driver circuitry 30 may supply image data to data lines D while issuing clock signals and other control signals to supporting display driver circuitry such as gate driver circuitry 34 over path 38. If desired, circuitry 30 may also supply clock signals and other control signals to gate driver circuitry on an opposing edge of display 14.

Gate driver circuitry 34 (sometimes referred to as horizontal control line control circuitry) may be implemented as part of an integrated circuit and/or may be implemented using thin-film transistor circuitry. Horizontal control lines G in display 14 may carry gate line signals (scan line signals), emission enable control signals, and other horizontal control signals for controlling the pixels of each row. There may be any suitable number of horizontal control signals per row of pixels 22 (e.g., one or more, two or more, three or more, four or more, etc.).

Display 14 may sometimes be a stereoscopic display that is configured to display three-dimensional content for a viewer. Stereoscopic displays are capable of displaying multiple two-dimensional images that are viewed from slightly different angles. When viewed together, the combination of the two-dimensional images creates the illusion of a three-dimensional image for the viewer. For example, a viewer's left eye may receive a first two-dimensional image and a viewer's right eye may receive a second, different two-dimensional image. The viewer perceives these two different two-dimensional images as a single three-dimensional image. Herein, a two-dimensional image refers to an image on a flat plate (such that the image has a measurable length and width but no measurable depth) whereas a three-dimensional image refers to an image that is solid rather than flat (such that the image appears to have a measurable depth in addition to a measurable length and width). A displayed three-dimensional image appears to have depth when viewed by a viewer. A three-dimensional image captured by an image sensor may include depth information across the captured scene.

There are numerous ways to implement a stereoscopic display. Display 14 may be a lenticular display that uses lenticular lenses (e.g., elongated lenses that extend along parallel axes), may be a parallax barrier display that uses parallax barriers (e.g., an opaque layer with precisely spaced slits to create a sense of depth through parallax), may be a volumetric display, or may be any other desired type of stereoscopic display. Configurations in which display 14 is a lenticular display are sometimes described herein as an example.

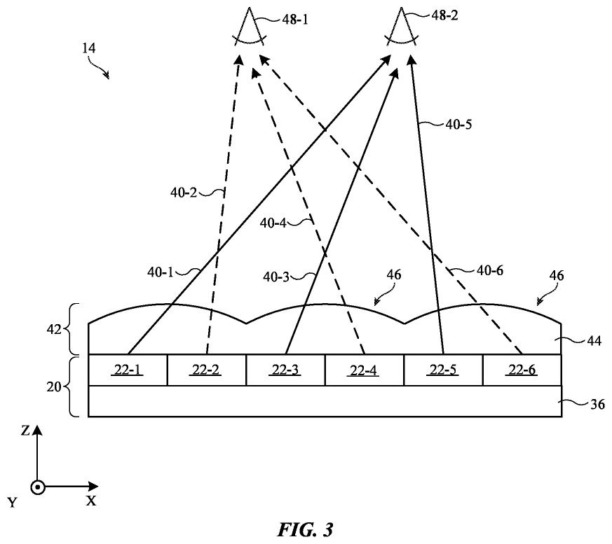

FIG. 3 is a cross-sectional side view of an illustrative lenticular display that may be incorporated into electronic device 10. Display 14 includes a display panel 20 with pixels 22 on substrate 36. Substrate 36 may be formed from glass, metal, plastic, ceramic, or other substrate materials and pixels 22 may be organic light-emitting diode pixels, liquid crystal display pixels, or any other desired type of pixels.

As shown in FIG. 3, lenticular lens film 42 may be formed over the display pixels. Lenticular lens film 42 (sometimes referred to as a light redirecting film, a lens film, etc.) includes lenses 46 and a base film portion 44 (e.g., a planar film portion to which lenses 46 are attached). Lenses 46 may be lenticular lenses that extend along respective longitudinal axes (e.g., axes that extend into the page parallel to the Y-axis). Lenses 46 may be referred to as lenticular elements 46, lenticular lenses 46, optical elements 46, etc.

The lenses 46 of the lenticular lens film cover the pixels of display 14. An example is shown in FIG. 3 with display pixels 22-1, 22-2, 22-3, 22-4, 22-5, and 22-6. In this example, display pixels 22-1 and 22-2 are covered by a first lenticular lens 46, display pixels 22-3 and 22-4 are covered by a second lenticular lens 46, and display pixels 22-5 and 22-6 are covered by a third lenticular lens 46. The lenticular lenses may redirect light from the display pixels to enable stereoscopic viewing of the display.

Consider the example of display 14 being viewed by a viewer with a first eye (e.g., a right eye) 48-1 and a second eye (e.g., a left eye) 48-2. Light from pixel 22-1 is directed by the lenticular lens film in direction 40-1 towards left eye 48-2, light from pixel 22-2 is directed by the lenticular lens film in direction 40-2 towards right eye 48-1, light from pixel 22-3 is directed by the lenticular lens film in direction 40-3 towards left eye 48-2, light from pixel 22-4 is directed by the lenticular lens film in direction 40-4 towards right eye 48-1, light from pixel 22-5 is directed by the lenticular lens film in direction 40-5 towards left eye 48-2, light from pixel 22-6 is directed by the lenticular lens film in direction 40-6 towards right eye 48-1. In this way, the viewer's right eye 48-1 receives images from pixels 22-2, 22-4, and 22-6, whereas left eye 48-2 receives images from pixels 22-1, 22-3, and 22-5. Pixels 22-2, 22-4, and 22-6 may be used to display a slightly different image than pixels 22-1, 22-3, and 22-5. Consequently, the viewer may perceive the received images as a single three-dimensional image.

Pixels of the same color may be covered by a respective lenticular lens 46. In one example, pixels 22-1 and 22-2 may be red pixels that emit red light, pixels 22-3 and 22-4 may be green pixels that emit green light, and pixels 22-5 and 22-6 may be blue pixels that emit blue light. This example is merely illustrative. In general, each lenticular lens may cover any desired number of pixels each having any desired color. The lenticular lens may cover a plurality of pixels having the same color, may cover a plurality of pixels each having different colors, may cover a plurality of pixels with some pixels being the same color and some pixels being different colors, etc.

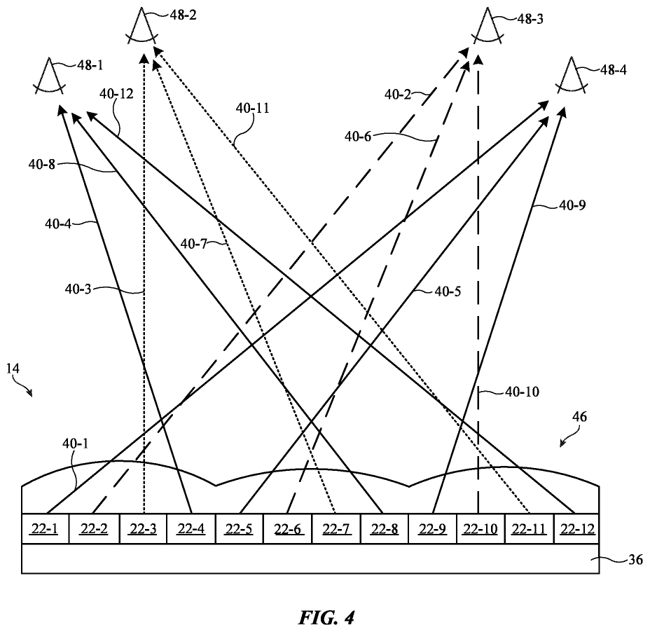

FIG. 4 is a cross-sectional side view of an illustrative stereoscopic display showing how the stereoscopic display may be viewable by multiple viewers. The stereoscopic display of FIG. 3 may have one optimal viewing position (e.g., one viewing position where the images from the display are perceived as three-dimensional). The stereoscopic display of FIG. 4 may have two or more optimal viewing positions (e.g., two or more viewing positions where the images from the display are perceived as three-dimensional).

Display 14 may be viewed by both a first viewer with a right eye 48-1 and a left eye 48-2 and a second viewer with a right eye 48-3 and a left eye 48-4. Light from pixel 22-1 is directed by the lenticular lens film in direction 40-1 towards left eye 48-4, light from pixel 22-2 is directed by the lenticular lens film in direction 40-2 towards right eye 48-3, light from pixel 22-3 is directed by the lenticular lens film in direction 40-3 towards left eye 48-2, light from pixel 22-4 is directed by the lenticular lens film in direction 40-4 towards right eye 48-1, light from pixel 22-5 is directed by the lenticular lens film in direction 40-5 towards left eye 48-4, light from pixel 22-6 is directed by the lenticular lens film in direction 40-6 towards right eye 48-3, light from pixel 22-7 is directed by the lenticular lens film in direction 40-7 towards left eye 48-2, light from pixel 22-8 is directed by the lenticular lens film in direction 40-8 towards right eye 48-1, light from pixel 22-9 is directed by the lenticular lens film in direction 40-9 towards left eye 48-4, light from pixel 22-10 is directed by the lenticular lens film in direction 40-10 towards right eye 48-3, light from pixel 22-11 is directed by the lenticular lens film in direction 40-11 towards left eye 48-2, and light from pixel 22-12 is directed by the lenticular lens film in direction 40-12 towards right eye 48-1. In this way, the first viewer's right eye 48-1 receives images from pixels 22-4, 22-8, and 22-12, whereas left eye 48-2 receives images from pixels 22-3, 22-7, and 22-11. Pixels 22-4, 22-8, and 22-12 may be used to display a slightly different image than pixels 22-3, 22-7, and 22-11. Consequently, the first viewer may perceive the received images as a single three-dimensional image. Similarly, the second viewer's right eye 48-3 receives images from pixels 22-2, 22-6, and 22-10, whereas left eye 48-4 receives images from pixels 22-1, 22-5, and 22-9. Pixels 22-2, 22-6, and 22-10 may be used to display a slightly different image than pixels 22-1, 22-5, and 22-9. Consequently, the second viewer may perceive the received images as a single three-dimensional image.

Pixels of the same color may be covered by a respective lenticular lens 46. In one example, pixels 22-1, 22-2, 22-3, and 22-4 may be red pixels that emit red light, pixels 22-5, 22-6, 22-7, and 22-8 may be green pixels that emit green light, and pixels 22-9, 22-10, 22-11, and 22-12 may be blue pixels that emit blue light. This example is merely illustrative. The display may be used to present the same three-dimensional image to both viewers or may present different three-dimensional images to different viewers. In some cases, control circuitry in the electronic device 10 may use eye and/or head tracking system 18 to track the position of one or more viewers and display images on the display based on the detected position of the one or more viewers.

It should be understood that the lenticular lens shapes and directional arrows of FIGS. 3 and 4 are merely illustrative. The actual rays of light from each pixel may follow more complicated paths (e.g., with redirection occurring due to refraction, total internal reflection, etc.). Additionally, light from each pixel may be emitted over a range of angles. The lenticular display may also have lenticular lenses of any desired shape or shapes. Each lenticular lens may have a width that covers two pixels, three pixels, four pixels, more than four pixels, more than ten pixels, more than fifteen pixels, less than twenty-five pixels, etc. Each lenticular lens may have a length that extends across the entire display (e.g., parallel to columns of pixels in the display).

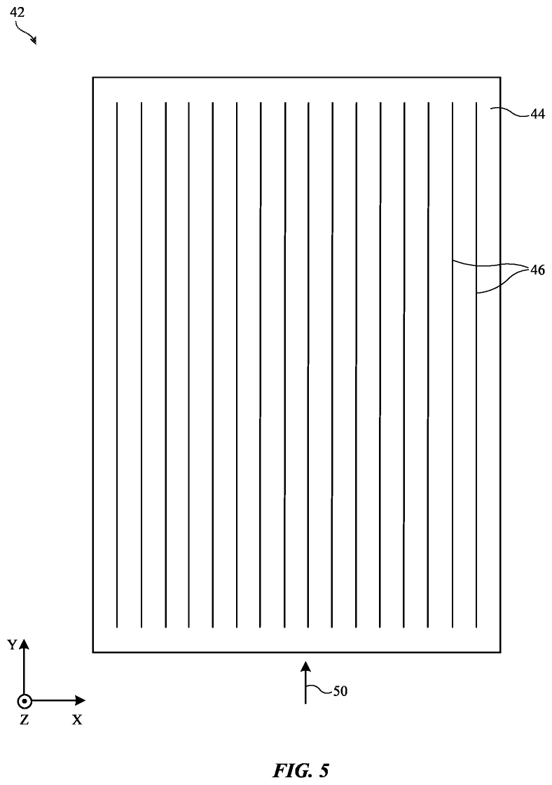

FIG. 5 is a top view of an illustrative lenticular lens film that may be incorporated into a lenticular display. As shown in FIG. 5, elongated lenses 46 extend across the display parallel to the Y-axis. For example, the cross-sectional side view of FIGS. 3 and 4 may be taken looking in direction 50. The lenticular display may include any desired number of lenticular lenses 46 (e.g., more than 10, more than 100, more than 1,000, more than 10,000, etc.). In FIG. 5, the lenticular lenses extend perpendicular to the upper and lower edge of the display panel. This arrangement is merely illustrative, and the lenticular lenses may instead extend at a non-zero, non-perpendicular angle (e.g., diagonally) relative to the display panel if desired.

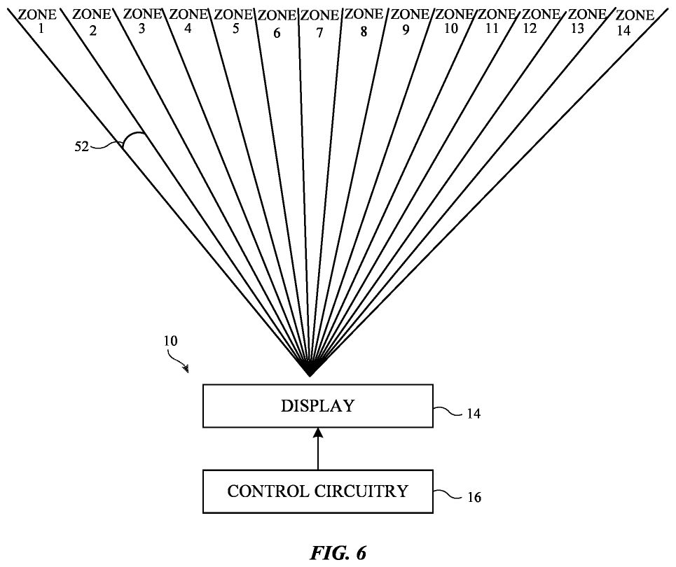

FIG. 6 is a schematic diagram of an illustrative electronic device showing control circuitry may be used to control operation of the display. As shown in FIG. 6, display 14 is capable of providing unique images across a number of distinct zones. In FIG. 6, display 14 emits light across 14 zones, each having a respective angle of view 52. The angle 52 may be between 1° and 2°, between 0° and 4°, less than 5°, less than 3°, less than 2°, less than 1.5°, greater than 0.5°, or any other desired angle. Each zone may have the same associated viewing angle or different zones may have different associated viewing angles.

The example herein of the display having 14 independently controllable zones is merely illustrative. In general, the display may have any desired number of independently controllable zones (e.g., more than 2, more than 6, more than 10, more than 12, more than 16, more than 20, more than 30, more than 40, less than 40, between 10 and 30, between 12 and 25, etc.).

Each zone is capable of displaying a unique image to the viewer. The sub-pixels on display 14 may be divided into groups, with each group of sub-pixels capable of displaying an image for a particular zone. For example, a first subset of sub-pixels in display 14 is used to display an image (e.g., a two-dimensional image) for zone 1, a second subset of sub-pixels in display 14 is used to display an image for zone 2, a third subset of sub-pixels in display 14 is used to display an image for zone 3, etc. In other words, the sub-pixels in display 14 may be divided into 14 groups, with each group associated with a corresponding zone (sometimes referred to as viewing zone) and capable of displaying a unique image for that zone. The sub-pixel groups may also themselves be referred to as zones.

Control circuitry 16 may control display 14 to display desired images in each viewing zone. There is much flexibility in how the display provides images to the different viewing zones. Display 14 may display entirely different content in different zones of the display. For example, an image of a first object (e.g., a cube) is displayed for zone 1, an image of a second, different object (e.g., a pyramid) is displayed for zone 2, an image of a third, different object (e.g., a cylinder) is displayed for zone 3, etc. This type of scheme may be used to allow different viewers to view entirely different scenes from the same display. However, in practice there may be crosstalk between the viewing zones. As an example, content intended for zone 3 may not be contained entirely within viewing zone 3 and may leak into viewing zones 2 and 4.

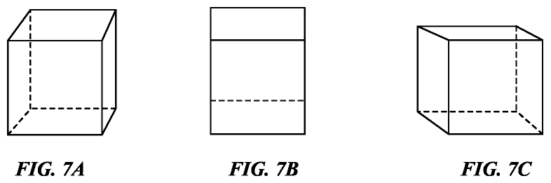

Therefore, in another possible use-case, display 14 may display a similar image for each viewing zone, with slight adjustments for perspective between each zone. This may be referred to as displaying the same content at different perspectives (or different views), with one image corresponding to a unique perspective of the same content. For example, consider an example where the display is used to display a three-dimensional cube. The same content (e.g., the cube) may be displayed on all of the different zones in the display. However, the image of the cube provided to each viewing zone may account for the viewing angle associated with that particular zone. In zone 1, for example, the viewing cone may be at a -10° angle relative to the surface normal of the display. Therefore, the image of the cube displayed for zone 1 may be from the perspective of a −10° angle relative to the surface normal of the cube (as in FIG. 7A). Zone 7, in contrast, is at approximately the surface normal of the display. Therefore, the image of the cube displayed for zone 7 may be from the perspective of a 0° angle relative to the surface normal of the cube (as in FIG. 7B). Zone 14 is at a 10° angle relative to the surface normal of the display. Therefore, the image of the cube displayed for zone 14 may be from the perspective of a 10° angle relative to the surface normal of the cube (as in FIG. 7C). As a viewer progresses from zone 1 to zone 14 in order, the appearance of the cube gradually changes to simulate looking at a real-world object.

There are many possible variations for how display 14 displays content for the viewing zones. In general, each viewing zone may be provided with any desired image based on the application of the electronic device. Different zones may provide different images of the same content at different perspectives, different zones may provide different images of different content, etc.

Ideally, each viewing zone would receive only one image from the display. For example, a first image is displayed in viewing zone 1, a second image is displayed in viewing zone 2, a third image is displayed in viewing zone 3, etc. In practice, there may be crosstalk between some of the adjacent viewing zones.

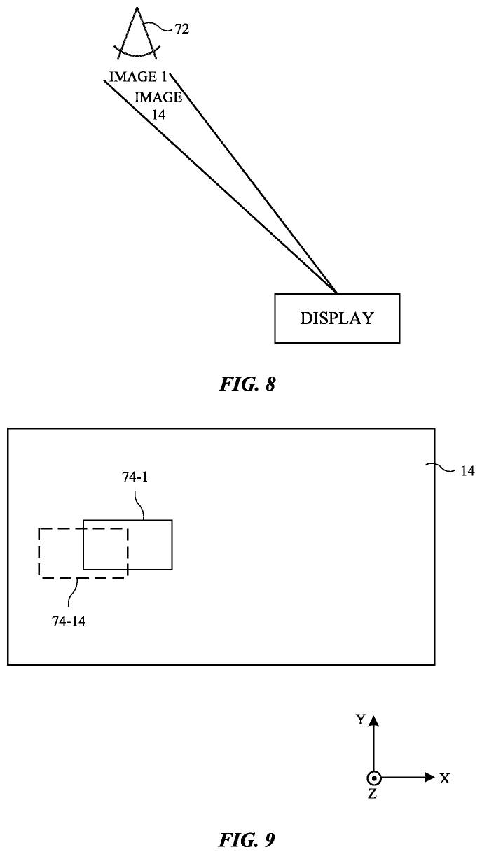

FIG. 8 is a diagram showing an example of crosstalk in a particular viewing zone. As shown, a viewer 72 may be positioned in a particular viewing zone (e.g., viewing zone 1 in FIG. 6). The display may display a first image (image 1) that is intended to be viewed at viewing zone 1. The display may also display an image (image 14) that is intended to be viewed at viewing zone 14 (see FIG. 6). However, due to the lenticular display design, image 14 may be viewable in viewing zone 1 in addition to intended viewing zone 14.

Consequently, viewer 72 may see both image 1 and image 14 at the same time. This type of crosstalk may cause visible artifacts such as ghosting for the viewer. An example of ghosting is shown in FIG. 9. FIG. 9 is a top view of the lenticular display 14 as seen by the viewer in FIG. 8. The lenticular display may attempt to display an object 74. Image 1 includes the object at a first position 74-1, as shown in FIG. 9. Image 14 includes the object at the second position 74-14, as shown in FIG. 9. The viewer therefore sees the same object in different positions on the display at the same time (even though the object is only intended to be displayed once). This phenomenon may be referred to as ghosting.

Ghosting may particularly be an issue between zones at the edges of the primary field of view of the display. For example, again consider the display shown in FIG. 6 and the example where the display displays a similar image for each viewing zone, with slight adjustments for perspective between each zone (e.g., the cube of FIGS. 7A-7C). The same content (e.g., the cube) may be displayed on all of the different zones in the display. However, the image of the cube provided to each viewing zone may account for the viewing angle associated with that particular zone.

Any two adjacent viewing zones within the primary field of view of the display (e.g., zones 1-14) may display very similar images. For example, consider zone 1 and zone 2. The image of the cube displayed for zone 1 may be from the perspective of a −10° angle relative to the surface normal of the cube. The image of the cube displayed for zone 2 may be from the perspective of a −9° angle relative to the surface normal of the cube. This slight difference in perspective may not be detectable to the viewer (or significantly detract from the viewing experience), even when there is crosstalk between zones 1 and 2.

Examining another two adjacent viewing zones such as zones 10 and 11, the result is similar. For example, the image of the cube displayed for zone 10 may be from the perspective of a +5° angle relative to the surface normal of the cube. The image of the cube displayed for zone 11 may be from the perspective of a +6° angle relative to the surface normal of the cube. This slight difference in perspective may not be detectable to the viewer (or significantly detract from the viewing experience), even when there is crosstalk between zones 10 and 11.

However, consider zones 1 and 14. The image of the cube displayed for zone 1 may be from the perspective of a −10° angle relative to the surface normal of the cube (as in FIG. 7A). The image of the cube displayed for zone 14 may be from the perspective of a +10° angle relative to the surface normal of the cube (as in FIG. 7C). This difference in the image may be detectable to the viewer when there is crosstalk between zones 1 and 14 (e.g., ghosting will occur).

The display may take steps to mitigate ghosting by selectively dimming portions of the image that are susceptible to ghosting. As previously discussed, the edge zones may be particularly susceptible to ghosting. Therefore, the selective dimming may be performed primarily in the edge zones (e.g., zones 1 and 14 in FIG. 6). In one possible embodiment, the selective dimming may be performed only in the edge zones (with no dimming in the non-edge zones).

To avoid excessively dimming the display, selective dimming may be performed only on content that is susceptible to ghosting. Ghosting may be particularly noticeable in areas of high contrast within the image (e.g., at borders), at areas of high luminance (e.g., bright objects) within the image, and/or at content-specific points of interest within the image (e.g., portions of the image that display important parts of the image). Portions of the image with low contrast and/or low luminance (e.g., portions of the image that are approximately the same across all of the viewing zones) may not be dimmed as these areas will not cause ghosting (or will not cause ghosting that detracts from the viewer experience).

Additionally, the ghosting could be eliminated by turning off un-occupied viewing zones. For example, in the example of FIG. 8, where the viewer is in viewing zone 1 but receives crosstalk from viewing zone 14, the image for viewing zone 14 may be turned off. However, this would result in viewing zone 14 being totally dark, which may be an undesirable artifact for the display (e.g., if another viewer is in zone 14, if viewer 72 moves to zone 14, etc.). By only selectively dimming portions of viewing zone 14, a viewer in viewing zone 14 may also have a satisfactory viewing experience.

The displayed content may be based on both a two-dimensional (2D) image and a three-dimensional (3D) image. In some cases, control circuitry may actively analyze the content to determine which portions of the displayed image will be vulnerable to ghosting. The portions identified as vulnerable may then undergo dimming to mitigate ghosting. The control circuitry may identify vulnerable portions based on the two-dimensional image and/or the three-dimensional image.

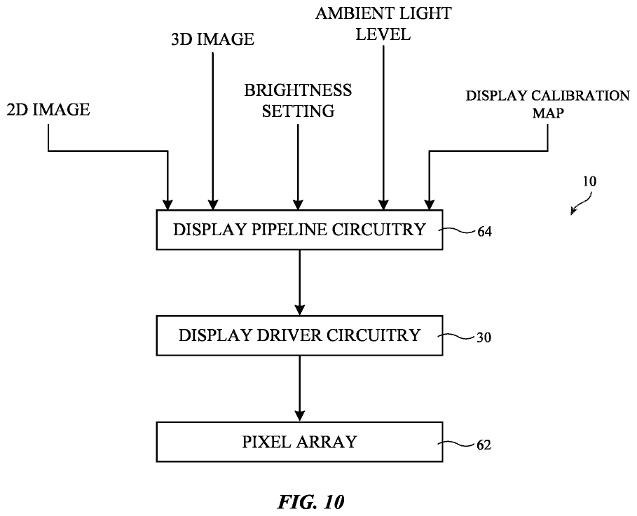

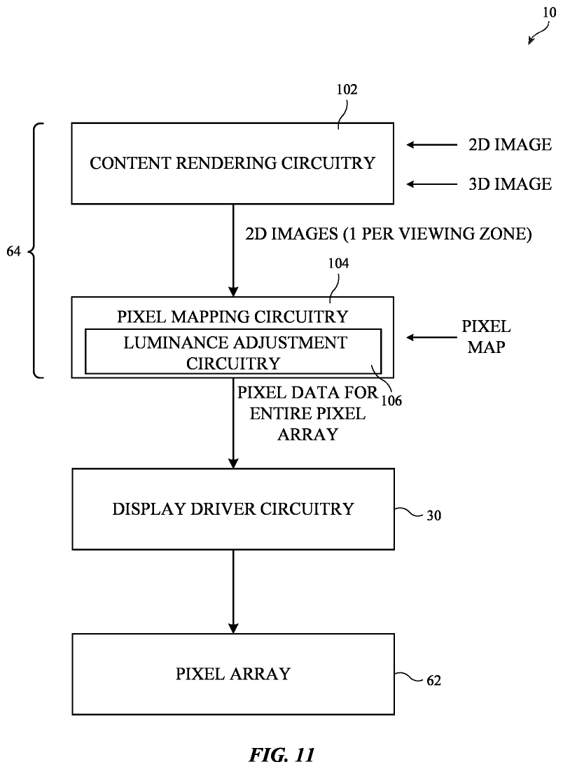

FIG. 10 is a schematic diagram of an electronic device including display pipeline circuitry. The display pipeline circuitry 64 provides pixel data to display driver circuitry 30 for display on pixel array 62. Pipeline circuitry 64 may use various inputs to render an image and generate pixel brightness values for each pixel in the pixel array based on the image. In the example of FIG. 10, the display may be used to provide images of the same content at different perspectives in each viewing zone. In other words, each subset of the pixel array associated with a given viewing zone displays a different view of the same content. As a viewer changes viewing zones, the appearance of the content gradually changes to simulate looking at a real-world object.

There are numerous steps that may be involved in display pipeline circuitry 64 generating pixel data for the pixel array. First, the display pipeline circuitry may render content that is intended to be displayed by the lenticular display. The display pipeline circuitry may render a plurality of two-dimensional images of target content, with each two-dimensional image corresponding to a different view of the target content. In one example, the target content may be based on a two-dimensional (2D) image and a three-dimensional (3D) image. The two-dimensional image and the three-dimensional image may optionally be captured by a respective two-dimensional image sensor and three-dimensional image sensor in electronic device 10. This example is merely illustrative. The content may be rendered based on two-dimensional/three-dimensional images from other sources (e.g., from sensors on another device, computer-generated images, etc.).

The two-dimensional images associated with different views may be compensated based on various factors (e.g., a brightness setting for the device, ambient light levels, etc.). After the two-dimensional images of different views are compensated, the plurality of two-dimensional images may be combined and provided to the single pixel array 62. A pixel map may be used to determine which pixels in the pixel array correspond to each view (e.g., each of the plurality of two-dimensional images). Additional compensation steps may be performed after determining the pixel data for the entire pixel array. Once the additional compensation is complete, the pixel data may be provided to the display driver circuitry 30. The pixel data provided to display driver circuitry 30 includes a brightness level (e.g., voltage) for each pixel in pixel array 62. These brightness levels are used to simultaneously display a plurality of two-dimensional images on the pixel array, each two-dimensional image corresponding to a unique view of the target content that is displayed in a respective unique viewing zone.

FIG. 11 is a schematic diagram of an electronic device showing details of the display pipeline circuitry. As shown, display pipeline circuitry 64 may include both content rendering circuitry 102 and pixel mapping circuitry 104. Display pipeline circuitry 64 may be considered part of control circuitry 16 in FIG. 1.

Content rendering circuitry 102 may render a two-dimensional image for each respective viewing zone in the display. In the example of FIG. 6, the display has 14 viewing zones. In this example, content rendering circuitry 102 would render 14 two-dimensional images, with one two-dimensional image for each viewing zone. As previously discussed, there is flexibility in the type of content that is displayed in each of the viewing zones. However, herein an illustrative example will be described where the viewing zones are used to display images of the same content at different perspectives (views). In other words, each subset of the pixel array associated with a given viewing zone displays a different view of the same content. As a viewer changes viewing zones, the appearance of the content gradually changes to simulate looking at a real-world object. Each one of the plurality of views (e.g., two-dimensional images) rendered by circuitry 102 may include a respective target brightness value for each pixel in a target two-dimensional image.

Content rendering circuitry 102 may render content for the plurality of views based on a received two-dimensional image and a three-dimensional image. The two-dimensional image and three-dimensional image may be images of the same content. In other words, the two-dimensional image may provide color/brightness information for given content while the three-dimensional image provides a depth map associated with the given content. The two-dimensional image only has color/brightness information for one view of the given content. However, content rendering circuitry 102 may render two-dimensional images for additional views (at different perspectives) based on the depth map and the two-dimensional image from the original view. Content rendering circuitry 102 may render as many two-dimensional images (views) as there are viewing zones in the display (e.g., more than 1, more than 2, more than 6, more than 10, more than 12, more than 16, more than 20, more than 30, more than 40, less than 40, between 10 and 30, between 12 and 25, etc.).

Content rendering circuitry 102 may optionally include a machine learning model. The machine learning model may use additional information (e.g., additional images of the content) to render two-dimensional images (views) for each viewing zone in the display.

Content rendering circuitry 102 may include storage such as hard disk drive storage, nonvolatile memory (e.g., flash memory or other electrically-programmable-read-only memory configured to form a solid-state drive), volatile memory (e.g., static or dynamic random-access-memory), etc. Content rendering circuitry 102 may also include one or more microprocessors, microcontrollers, digital signal processors, baseband processors, power management units, application specific integrated circuits, graphics processing units (GPUs), etc.

Additional per-view processing circuitry (sometimes referred to as per-2D-image compensation circuitry) may be included in the device if desired. The per-view processing circuitry may individually process each two-dimensional image rendered by circuitry 102 before the images are mapped by pixel mapping circuitry 104. The per-view processing circuitry is used to make content adjustments that are based on the perceived image that ultimately reaches the viewer (e.g., the pixels that are adjacent on the user's retina when viewing the display). As examples, the per-view processing circuitry may include one or more of tone mapping circuitry, ambient light adaptation circuitry, white point calibration circuitry, and dithering circuitry, and/or any other desired processing circuitry.

Pixel mapping circuitry 104 may include storage such as hard disk drive storage, nonvolatile memory (e.g., flash memory or other electrically-programmable-read-only memory configured to form a solid-state drive), volatile memory (e.g., static or dynamic random-access-memory), etc. Pixel mapping circuitry 104 may also include one or more microprocessors, microcontrollers, digital signal processors, baseband processors, power management units, application specific integrated circuits, graphics processing units (GPUs), etc.

After optional per-view processing is complete, the multiple 2D images from content rendering circuitry 102 may be provided to pixel mapping circuitry 104. Pixel mapping circuitry 104 may receive all of the two-dimensional images that are produced by content rendering circuitry 102. Pixel mapping circuitry 104 may also receive (or include) a pixel map (sometimes referred to as a display calibration map) that indicates how each view corresponds to the pixel array. The pixel map may also include texture information that identifies the texture (u, v) associated with each pixel.

For example, the pixel mapping circuitry may receive a first two-dimensional image that corresponds to a first view intended for viewing zone 1 of the display. The display calibration map may identify a first subset of pixels in the pixel array that is visible at viewing zone 1. Accordingly, the first two-dimensional image is mapped to the first subset of pixels. Once displayed, the first two-dimensional image is viewable at viewing zone 1. The pixel mapping circuitry may also receive a second two-dimensional image that corresponds to a second view intended for viewing zone 2 of the display. The display calibration map may identify a second subset of pixels in the pixel array that is visible at viewing zone 2. Accordingly, the second two-dimensional image is mapped to the second subset of pixels. Once displayed, the second two-dimensional image is viewable at viewing zone 2. This type of pixel mapping is repeated for every view included in the display. Once complete, pixel mapping circuitry 104 outputs pixel data for each pixel in the pixel array. The pixel data includes a blend of all the independent, two-dimensional images from content rendering circuitry 102.

It should be understood that the subset of pixels used to display each view may be non-continuous. For example, the subset of pixels for each view may include a plurality of discrete vertical pixel strips. These discrete sections of pixels may be separated by pixels that are used to display other views to the viewer.

After pixel mapping is complete, panel-level processing circuitry may optionally be used to perform additional processing on the pixel data. Panel-level processing circuitry may include one or more of color compensation circuitry, border masking circuitry, burn-in compensation circuitry, and panel response correction circuitry. In contrast to the aforementioned per-view processing circuitry, panel-level processing circuitry may be used to make adjustments that are based on the pixels on the display panel (as opposed to perceived pixels at the user's eye).

After the panel-level processing is complete, the pixel data for the entire pixel array may be provided to display driver circuitry 30, where it is subsequently displayed on pixel array 62.

It should be noted that per-view processing circuitry (e.g., processing in the view space) is used to process the pixel data before pixel mapping whereas panel-level processing circuitry (e.g., processing in the display panel space) is used to process the pixel data after pixel mapping. This allows processing that relies on the final view of the image (e.g., per-view processing) to be completed before the data is split to a subset of pixels on the panel and interleaved with other views during pixel mapping. Once pixel mapping is complete, the processing that relies on the full panel luminance values (e.g., panel-level processing) may be completed.

While mapping the 2D images from content rendering circuitry 102 to the pixel array of display 14, pixel mapping circuitry 104 may selectively adjust the brightness of the pixel values. For example, pixel mapping circuitry 104 may selectively dim some of the pixel values to mitigate ghosting. As another example, pixel mapping circuitry 104 may selectively increase the brightness (i.e., boost) some of the pixel values to increase contrast. Pixel mapping circuitry 104 may use luminance adjustment circuitry 106 (sometimes referred to as view-dependent luminance adjustment circuitry 106, view-dependent spatial luminance adjustment circuitry 106, etc.) to selectively adjust the pixel values.

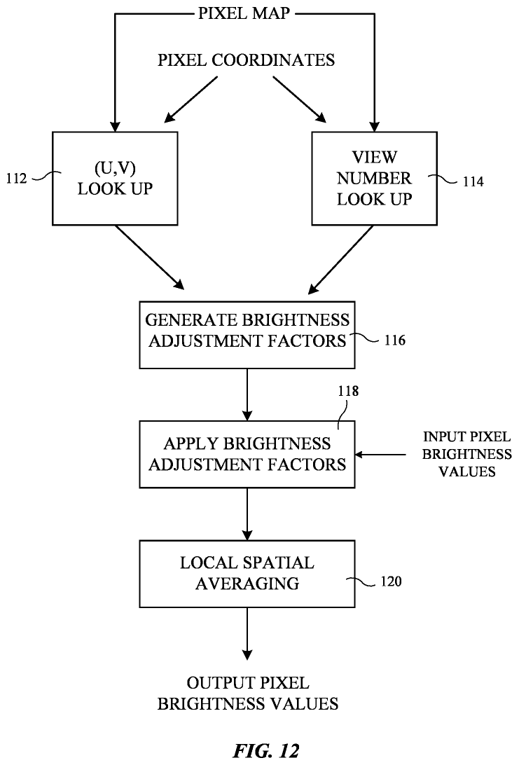

FIG. 12 is a flowchart of illustrative method steps that view-dependent luminance adjustment circuitry 106 may use to selectively adjust the pixel brightness values. First, the pixel coordinates of the pixels in the lenticular display may be used to identify a texture and view number associated with each pixel.

The texture information (u, v) is identified at step 112 based on each pixel coordinate and the pixel map. For example, a first pixel in the lenticular display may have a corresponding pixel coordinate. The pixel map may be used to identify a texture that corresponds to that particular pixel coordinate. The pixel map may have texture information for each pixel based on the 3D image that is used to generate the 2D images. The texture information may sometimes be referred to as depth information.

The view number associated with a given pixel coordinate is identified at step 114 based on the pixel coordinate and the pixel map. For example, a first pixel in the lenticular display may have a corresponding pixel coordinate. The pixel map may be used to identify a viewing zone to which that particular pixel coordinate belongs.

The pixel map may have a viewing zone associated with each pixel based on calibration information (e.g., the display may be tested to determine the viewing zone to which each pixel in the display belongs). The viewing zone of each pixel does not change over time during operation of the display. However, the texture information (e.g., the UV map portion of the pixel map) may intermittently be updated at some frequency during operation of the display.

Next, at step 116, the view-dependent luminance adjustment circuitry 106 may generate brightness adjustment factors (sometimes referred to as adjustment factors, dimming factors, or boosting factors) for each pixel based on the view number and texture of each pixel. First, the example of dimming the pixels to mitigate ghosting will be described. The dimming factors may be between (and including) 0 and 1 and may be multiplied by the original brightness value. For example, a dimming factor of 0 would mean that the input brightness value is dimmed to 0 (e.g., that pixel has a brightness of 0 and is effectively turned off). A dimming factor of 1 would mean that the input brightness value is unchanged (e.g., that pixel is not dimmed). A dimming factor of 0.9 would mean that an output brightness value has a brightness that is 90% of its corresponding input brightness value. These examples of possible values for the dimming factors are merely illustrative. Any possible values may be used for the dimming factors. As another possible example, the dimming factors may be subtracted from the input pixel brightness values to dim the pixel brightness values. For example, the input pixel brightness values may be between (and including) 0 and 255. Consider, as an example, an input pixel brightness value of 200. A dimming factor of 0 would mean that the pixel is not dimmed (because no brightness reduction occurs, and the brightness remains 200). The dimming factor may be 60, resulting in the brightness value being reduced to 140 (e.g., 200-60 =140). In general, any scheme may be used for the magnitudes and application of the dimming factors (e.g., Brightness_{OUTPUT}=Brightness_{INPUT}−Dimming Factor, Brightness_{OUTPUT}=Brightness_{INPUT}×Dimming Factor, etc.).

As previously mentioned, the dimming factors may be applied primarily to the edge viewing zones in the display. In other words, the lenticular display has a ^{th} order (primary) field of view with a plurality of viewing zones. The viewing zones on the edge of this field of view may receive dimming factors whereas the viewing zones at the center of this field of view may not. In one possible embodiment, only the edge-most viewing zones have any applied dimming In another possible embodiment, viewing zones in addition to the edge-most viewing zones may have applied dimming However, in general, the amount of dimming may diminish with increasing distance from the edge of the field of view.

As an example, a first pixel may have a first associated texture value (u, v) and be part of viewing zone 1 (e.g., at the edge of the primary field of view). A second pixel may have a second associated texture value (u, v) and be part of viewing zone 7 (e.g., closer to the center of the primary field of view than zone 1). The second texture value may be the same (or similar) as the first texture value (e.g., both texture values indicate an area that is vulnerable to ghosting). However, the first pixel may be assigned a dimming factor that results in greater dimming than the second pixel. The brightness of the second pixel may not be dimmed whereas the brightness of the first pixel may be dimmed by more than 1%, more than 5%, more than 10%, more than 20%, more than 40%, more than 50%, more than 75%, etc.

In the example of FIG. 12, the texture of a given pixel may be used to determine whether or not the pixel is vulnerable to ghosting. For example, the display may typically show the same content. The content may consistently have the same luminance and texture patterns. Specific areas of the content may be vulnerable to ghosting artifacts. Because the content consistently has the same luminance and texture patterns, the texture identified in step 112 may be sufficient to know if the pixel is in an area that is vulnerable to ghosting or not vulnerable to ghosting.

As an example, a first pixel may have a first associated texture value (u, v) and be part of viewing zone 1 (e.g., at the edge of the primary field of view). A second pixel may have a second associated texture value (u, v) and also be part of viewing zone 1. Both pixels are at the edge of the field of view and are vulnerable to ghosting from this respect. However, the first texture value may be associated with content that is vulnerable to ghosting artifacts whereas the second texture value may be associated with content that is not vulnerable (or less vulnerable) to ghosting artifacts. Therefore, the first pixel may be assigned a dimming factor that results in greater dimming than the second pixel. The brightness of the second pixel may not be dimmed whereas the brightness of the first pixel may be dimmed by more than 1%, more than 5%, more than 10%, more than 20%, more than 40%, more than 50%, more than 75%, etc.

The example of generating dimming factors based on texture and view number is merely illustrative. This type of dimming factor generation scheme may be suitable to applications where the display is typically displaying the same content (and therefore portions of the content that are vulnerable to ghosting may be identified from texture alone). However, in other applications, it may be desirable to (instead or in addition) determine which portions of the content are vulnerable to ghosting using luminance values. The luminance values may be used to identify high contrast regions (e.g., edges) in the content that may be vulnerable to ghosting. Pixels displaying the vulnerable content may then receive greater dimming factors than pixels displaying the non-vulnerable content.

In addition to or instead of using the aforementioned dimming factors, luminance adjustment circuitry 106 may also generate boosting factors (that selectively increase the brightness of the pixels) at step 116. The form factor of display 14 and/or expected position of the viewer of the display may result in some portions of display 14 being more susceptible to reflections (of ambient light) than others. For example, the edges of display 14 may have high reflections of ambient light that are visible to the viewer (in bright ambient light conditions). If care is not taken, these reflections may reduce contrast in the edges of the display, negatively impacting the appearance of the display.

To mitigate this issue, boosting factors that selectively increase the brightness of the pixels may be generated at step 116. The boosting factors may be selected based on the pixel coordinate of the given pixel. For example, a first pixel with a coordinate that is present in the known reflection-susceptible region of the display (e.g., the edge) may receive a boosting factor to increase that pixel's luminance. A second pixel with a coordinate that is not present in the known reflection-susceptible region of the display (e.g., located in the center of the display) may not receive a boosting factor (so that pixel's luminance is not increased).

The boosting factors may be greater than 1 and may be multiplied by the original brightness value. For example, a dimming factor of 1.1 would mean that the input brightness value is boosted to 1.1 times the original brightness. A boosting factor of 1 would mean that the input brightness value is unchanged (e.g., that pixel is not boosted). These examples of possible values for the boosting factors are merely illustrative. Any possible values may be used for the boosting factors. As another possible example, the boosting factors may be added to the input pixel brightness values to boost the pixel brightness values. For example, the input pixel brightness values may be between (and including) 0 and 255. Consider, as an example, an input pixel brightness value of 200. A boosting factor of 0 would mean that the pixel is not boosted (because no brightness increase occurs, and the brightness remains 200). The boosting factor may be 20, resulting in the brightness value being increased to 220 (e.g., 200+20=220). In general, any scheme may be used for the magnitudes and application of the boosting factors (e.g., Brightness_{OUTPUT}=Brightness_{INPUT}+Boosting Factor, Brightnes_{OUTPUT}=Brightness_{INPUT}×Boosting Factor, etc.).

For simplicity, the same scheme may be used for the brightness adjustment factors whether or not the brightness adjustment factor increases (boosts) or decreases (dims factor) the pixel brightness. This allows a single brightness adjustment factor to be provided for each pixel, with some of the brightness adjustment factors causing luminance increase, some of the brightness adjustment factors causing luminance decrease, and some of the brightness adjustment factors causing no luminance change. A multiplication scheme may be used, with brightness adjustment factors greater than 1 causing an increase in brightness and brightness adjustment factors less than 1 causing a decrease in brightness. Alternatively, an addition/subtraction scheme may be used, with positive brightness adjustment factors causing an increase in brightness and negative brightness adjustment factors causing a decrease in brightness. In general, any desired scheme may be used that allows the brightness adjustment factors to selectively increase and/or decrease the pixel luminance

At step 118, the brightness adjustment factors may be applied to the input pixel brightness values. The input pixel brightness values may already have been mapped to the display panel space by pixel mapping circuitry 104. For each pixel coordinate, the input brightness value for that coordinate is adjusted by the corresponding brightness adjustment factor determined for that coordinate in step 116. Depending on the type of brightness adjustment factor used, the brightness adjustment factor may be multiplied by the input brightness value, subtracted from the input brightness value, etc.

Finally, at step 120, local spatial averaging may be performed to smooth the image and prevent mura. The local spatial averaging may be performed at the panel-level (e.g., panel-level processing). This means that the averaging is performed after the 2D images for each view are mapped to the display pixels on the lenticular display. For each pixel in the display, that pixel may be averaged with the 8 surrounding pixels. In other words, each pixel is made the center of a 3×3 grid of pixels. The average of the brightness values of the 3×3 grid of pixels is subsequently used as the brightness value for the center pixel of the 3×3 grid. The average may be a true average where all 9 pixel brightness values of the grid are weighted equally or may be a weighted average (e.g., the center pixel of the 3x3 grid may have a higher weight in the averaging than the surrounding pixels).

The example of using a 3×3 grid for the averaging is also illustrative. In general, any desired averaging scheme involving any number of adjacent pixels (e.g., a 5×5 grid with 25 total pixels, a ‘+’ arrangement with 5 total pixels, etc.) may be used.

After the local spatial averaging is performed, the brightness values may be output to display driver circuitry 30 for display on the lenticular display.

In accordance with an embodiment, an electronic device is provided that includes a display that includes an array of pixels and a lenticular lens film formed over the array of pixels, the display has a plurality of independently controllable viewing zones across a primary field of view and the plurality of independently controllable viewing zones include first and second edge viewing zones at respective first and second edges of the primary field of view; and control circuitry configured to render content for the display, the rendered content includes two-dimensional images that are each associated with a respective viewing zone; and dim at least some of the pixels in at least one of the first and second edge viewing zones.

In accordance with another embodiment, the control circuitry is further configured to map each two-dimensional image to respective pixels on the array of pixels to obtain pixel data for the array of pixels.

In accordance with another embodiment, the dimming at least some of the pixels in at least one of the first and second edge viewing zones include dimming at least some of the pixels based on content information for the pixels.

In accordance with another embodiment, the content information includes texture information.

In accordance with another embodiment, the content information includes luminance information.

In accordance with another embodiment, the two-dimensional images that are each associated with a respective viewing zone are two-dimensional images of the same content at different perspectives.

In accordance with another embodiment, the plurality of independently controllable viewing zones includes a central viewing zone, the control circuitry is configured to dim pixels in the first edge viewing zone associated with a given portion of the content by a first amount, and the control circuitry is configured to dim pixels in the central viewing zone associated with the given portion of the content by a second amount that is less than the first amount.

In accordance with another embodiment, dimming at least some of the pixels in at least one of the first and second edge viewing zones include, for each pixel: determine a texture associated with the pixel; determine a viewing zone associated with the pixel; and generating a dimming factor based on the texture and the viewing zone.

In accordance with another embodiment, dimming at least some of the pixels in at least one of the first and second edge viewing zones includes, for each pixel: applying the dimming factor for that pixel to an input brightness value for that pixel to determine a modified brightness value.

In accordance with another embodiment, the control circuitry is further configured to perform local spatial averaging on the modified brightness values for the array of pixels.

In accordance with another embodiment, performing local spatial averaging includes, for each pixel in the array of pixels, adjusting the modified brightness value for that pixel based on the modified brightness value of at least one adjacent pixel to determine an output brightness value.

In accordance with an embodiment, an electronic device is provided that includes a display that includes an array of pixels and a lenticular lens film formed over the array of pixels, the display has a plurality of independently controllable viewing zones; and control circuitry configured to: render content for the display, the rendered content includes two-dimensional images that are each associated with a respective viewing zone; map each two-dimensional image to respective pixels on the array of pixels to obtain brightness values for the array of pixels; and for each pixel in the array of pixels, selectively adjust the brightness value for that pixel based on the viewing zone to which that pixel belongs.

In accordance with another embodiment, the brightness values of pixels in a first viewing zone at an edge of a field of view of the display are adjusted by a greater amount than the brightness values of pixels in a second viewing zone at a center of the field of the view of the display.

In accordance with another embodiment, selectively adjusting the brightness value for each pixel includes selectively adjusting the brightness value for each respective pixel based on the viewing zone to which that pixel belongs and content information associated with that pixel.

In accordance with another embodiment, the content information includes texture information.

In accordance with another embodiment, the control circuitry is configured to generate the texture information based at least on a three-dimensional image of the content on the display.

In accordance with another embodiment, the content information includes brightness information.

In accordance with another embodiment, the control circuitry is configured to, for each pixel in the array of pixels, selectively adjust the brightness value for that pixel based on the viewing zone to which that pixel belongs and based on the position of that pixel within the array of pixels.

In accordance with an embodiment, an electronic device is provided that includes a display that includes an array of pixels and a lenticular lens film formed over the array of pixels, the display has a plurality of independently controllable viewing zones; content rendering circuitry configured to render content for the display, the rendered content includes two-dimensional images that are each associated with a respective viewing zone; and pixel mapping circuitry configured to map each two-dimensional image to respective pixels on the array of pixels to obtain pixel data for the array of pixels, the pixel mapping circuitry includes view-dependent luminance adjustment circuitry configured to adjust a brightness of at least some of the pixels in the array of pixels based at least partially on the viewing zone of each pixel.

In accordance with another embodiment, rendering the content for the display includes rendering the content based on a two-dimensional image of the content and a three-dimensional image of the content.

In accordance with another embodiment, the view-dependent luminance adjustment circuitry is configured to adjust the brightness of at least some of the pixels in the array of pixels based at least partially on the viewing zone of each pixel and a texture value of each pixel.

In accordance with an embodiment, an electronic device is provided that includes a display that includes an array of pixels and a lenticular lens film formed over the array of pixels, the display has a plurality of independently controllable viewing zones; and control circuitry configured to: render content for the display, the rendered content includes two-dimensional images that are each associated with a respective viewing zone; map each two-dimensional image to respective pixels on the array of pixels to obtain brightness values for the array of pixels; and for each pixel in the array of pixels, selectively increase the brightness value for that pixel based on the position of that pixel within the array of pixels.

The foregoing is merely illustrative and various modifications can be made to the described embodiments. The foregoing embodiments may be implemented individually or in any combination.

What is claimed is:

1. An electronic device comprising:
a display that includes an array of pixels and a lenticular lens film formed over the array of pixels, wherein the display has a plurality of independently controllable viewing zones across a primary field of view and wherein the plurality of independently controllable viewing zones comprises first and second edge viewing zones at respective first and second edges of the primary field of view; and
control circuitry configured to:
render content for the display, wherein the rendered content includes two-dimensional images that are each associated with a respective viewing zone; and
dim at least some of the pixels in at least one of the first and second edge viewing zones.

2. The electronic device defined in claim 1, wherein the control circuitry is further configured to map each two-dimensional image to respective pixels on the array of pixels to obtain pixel data for the array of pixels.

3. The electronic device defined in claim 1, wherein the dimming at least some of the pixels in at least one of the first and second edge viewing zones comprises dimming at least some of the pixels based on content information for the pixels.

4. The electronic device defined in claim 3, wherein the content information comprises texture information.

5. The electronic device defined in claim 3, wherein the content information comprises luminance information.

6. The electronic device defined in claim 1, wherein the two-dimensional images that are each associated with a respective viewing zone are two-dimensional images of the same content at different perspectives.

7. The electronic device defined in claim 6, wherein the plurality of independently controllable viewing zones comprises a central viewing zone, wherein the control circuitry is configured to dim pixels in the first edge viewing zone associated with a given portion of the content by a first amount, and wherein the control circuitry is configured to dim pixels in the central viewing zone associated with the given portion of the content by a second amount that is less than the first amount.

8. The electronic device defined in claim 1, wherein dimming at least some of the pixels in at least one of the first and second edge viewing zones comprises, for each pixel:
determine a texture associated with the pixel;
determine a viewing zone associated with the pixel; and
generating a dimming factor based on the texture and the viewing zone.

9. The electronic device defined in claim 8, wherein dimming at least some of the pixels in at least one of the first and second edge viewing zones further comprises, for each pixel:
applying the dimming factor for that pixel to an input brightness value for that pixel to determine a modified brightness value.

10. The electronic device defined in claim 9, wherein the control circuitry is further configured to perform local spatial averaging on the modified brightness values for the array of pixels.

11. The electronic device defined in claim 10, wherein performing local spatial averaging comprises, for each pixel in the array of pixels, adjusting the modified brightness value for that pixel based on the modified brightness value of at least one adjacent pixel to determine an output brightness value.

12. An electronic device comprising:
a display that includes an array of pixels and a lenticular lens film formed over the array of pixels, wherein the display has a plurality of independently controllable viewing zones; and
control circuitry configured to:
render content for the display, wherein the rendered content includes two-dimensional images that are each associated with a respective viewing zone;
map each two-dimensional image to respective pixels on the array of pixels to obtain brightness values for the array of pixels; and
for each pixel in the array of pixels, selectively adjust the brightness value for that pixel based on the viewing zone to which that pixel belongs.

13. The electronic device defined in claim 12, wherein the brightness values of pixels in a first viewing zone at an edge of a field of view of the display are adjusted by a greater amount than the brightness values of pixels in a second viewing zone at a center of the field of the view of the display.

14. The electronic device defined in claim 12, wherein selectively adjusting the brightness value for each pixel comprises selectively adjusting the brightness value for each respective pixel based on the viewing zone to which that pixel belongs and content information associated with that pixel.

15. The electronic device defined in claim 14, wherein the content information comprises texture information.

16. The electronic device defined in claim 15, wherein the control circuitry is configured to generate the texture information based at least on a three-dimensional image of the content on the display.

17. The electronic device defined in claim 14, wherein the content information comprises brightness information.

18. The electronic device defined in claim 12, wherein the control circuitry is configured to, for each pixel in the array of pixels, selectively adjust the brightness value for that pixel based on the viewing zone to which that pixel belongs and based on the position of that pixel within the array of pixels.

19. An electronic device comprising:
a display that includes an array of pixels and a lenticular lens film formed over the array of pixels, wherein the display has a plurality of independently controllable viewing zones;
content rendering circuitry configured to render content for the display, wherein the rendered content includes two-dimensional images that are each associated with a respective viewing zone; and
pixel mapping circuitry configured to map each two-dimensional image to respective pixels on the array of pixels to obtain pixel data for the array of pixels, wherein the pixel mapping circuitry includes view-dependent luminance adjustment circuitry configured to adjust a brightness of at least some of the pixels in the array of pixels based at least partially on the viewing zone of each pixel.

20. The electronic device defined in claim 19, wherein rendering the content for the display comprises rendering the content based on a two-dimensional image of the content and a three-dimensional image of the content.

21. The electronic device defined in claim 19, wherein the view-dependent luminance adjustment circuitry is configured to adjust the brightness of at least some of the pixels in the array of pixels based at least partially on the viewing zone of each pixel and a texture value of each pixel.

22. An electronic device comprising:
a display that includes an array of pixels and a lenticular lens film formed over the array of pixels, wherein the display has a plurality of independently controllable viewing zones; and
control circuitry configured to:
render content for the display, wherein the rendered content includes two-dimensional images that are each associated with a respective viewing zone;
map each two-dimensional image to respective pixels on the array of pixels to obtain brightness values for the array of pixels; and
for each pixel in the array of pixels, selectively increase the brightness value for that pixel based on the position of that pixel within the array of pixels.
